(19) United States
(12) Patent Application Publication
(10) Pub. No.: US 2022/0311070 A1
(43) Pub. Date: Sep. 29, 2022

(54) VEHICLE BATTERY COVER

(71) Applicant: MEIWA INDUSTRY CO., LTD., Kanagawa (JP)

(72) Inventor: Yoshitatsu TANAKA, Gifu (JP)

(21) Appl. No.: 17/684,893

(22) Filed: Mar. 2, 2022

(30) Foreign Application Priority Data
Mar. 29, 2021 (JP) 2021-054975

(51) Int. Cl. H01M 10/625; H01M 50/148; H01M 10/658; H01M 50/116

(52) U.S. Cl. CPC H01M 10/625; H01M 50/148; H01M 10/658; H01M 50/116; H01M 2220/20

(57) ABSTRACT

A cover body configured to surround a battery mounted on a vehicle is formed by combining two resin plates. The resin plates include quadrangular body portions and side surfaces formed on both sides of the body portions via hinges. Each of the side surfaces of the resin plates is formed with at least either a connecting piece extending in a vertical direction or a hole portion into which the connecting piece is inserted. The side surfaces of the two resin plates are superposed on each other in a state where the body portions of the two resin plates face each other, and the two resin plates are connected to each other by inserting the connecting piece into the hole portion.

### CROSS REFERENCE TO RELATED APPLICATION

This application is based upon and claims the benefit of priority under 35 U.S.C.§ 119 from Japanese Patent Application No. 2021-054975 filed on Mar. 29, 2021, the entire contents of which are incorporated herein by reference.

### TECHNICAL FIELD

The present invention relates to a vehicle battery cover.

### BACKGROUND

A vehicle is provided with batteries, many of which are installed in an engine compartment. The interior of the engine compartment is heated by heat radiated from an internal combustion engine. If the temperature of the battery is too low, the battery is not be able to achieve sufficient performance, and if the temperature is too high, the performance of the battery degrades. Thus, there is a known cover that is attached to a battery and used to insulate the battery from heat in the engine compartment.

As this kind of a battery cover, a resin cover molded into a box shape by means of injection molding is generally used. However, such a cover results in a high manufacturing cost because an injection molding die is necessary, and has a problem of being bulky during transportation due to the box shape, and thus improvements are desired in relation to such problems.

In view of such problems, a foldable battery cover using a resin plate has been proposed (see Utility Model Registration No. 3122083).

### SUMMARY

However, in the battery cover as described above, the ends of the resin plate formed as a frame-shaped cover body are connected to each other by bolt fastening or insertion hook fastening, and in the case of bolt fastening, the bolt may interfere with the battery, and in the case of an insertion hook, the insertion hook may come off.

Accordingly, an object of the present invention is to reduce interference between a connecting portion of a cover body and a battery, and to improve the connecting strength of the connecting portion of the cover body.

A vehicle battery cover according to the present invention includes a cover body configured to surround a battery mounted on a vehicle, and the cover body is formed by combining two resin plates. The resin plates include quadrangular body portions and side surfaces formed on both sides of the body portions via hinges, and each of the side surfaces of the resin plates is formed with at least either a connecting piece extending in a vertical direction or a hole portion into which the connecting piece is inserted. The side surfaces of the two resin plates are superposed on each other in a state where the body portions of the two resin plates face each other, and the two resin plates are connected to each other by inserting the connecting piece into the hole portion.

A vehicle battery cover of the present invention makes it possible to reduce interference between the connecting portion of the cover body and the battery, and improve the connecting strength of the connecting portion of the cover body.

### BRIEF DESCRIPTION OF THE DRAWINGS

FIG. 1 is a perspective view of a vehicle battery cover according to an embodiment.

FIG. 2 is a plan view of the vehicle battery cover according to the embodiment.

FIG. 3 is a side view of the vehicle battery cover according to the embodiment.

FIG. 4 is a developed view of a resin plate shown in FIGS. 1 to 3.

FIG. 5 is a perspective view showing a state in which a vehicle battery cover according to another embodiment is attached to a battery.

FIG. 6 is a perspective view of a vehicle battery cover according to another embodiment.

FIG. 7 is a plan view of the vehicle battery cover according to another embodiment.

FIG. 8 is a side view of the vehicle battery cover according to another embodiment.

FIG. 9 is a developed view of a resin plate shown in FIGS. 5 to 8.

FIG. 10 is a developed view of the resin plate shown in FIGS. 5 to 8.

FIG. 11 is a perspective view of a vehicle battery cover according to yet another embodiment.

FIG. 12 is a plan view of the vehicle battery cover according to yet another embodiment.

FIG. 13 is a side view of the vehicle battery cover according to yet another embodiment.

FIG. 14 is a developed view of a resin plate shown in FIGS. 11 to 13.

### DETAILED DESCRIPTION

An embodiment of the present invention will be described in detail with reference to the drawings.

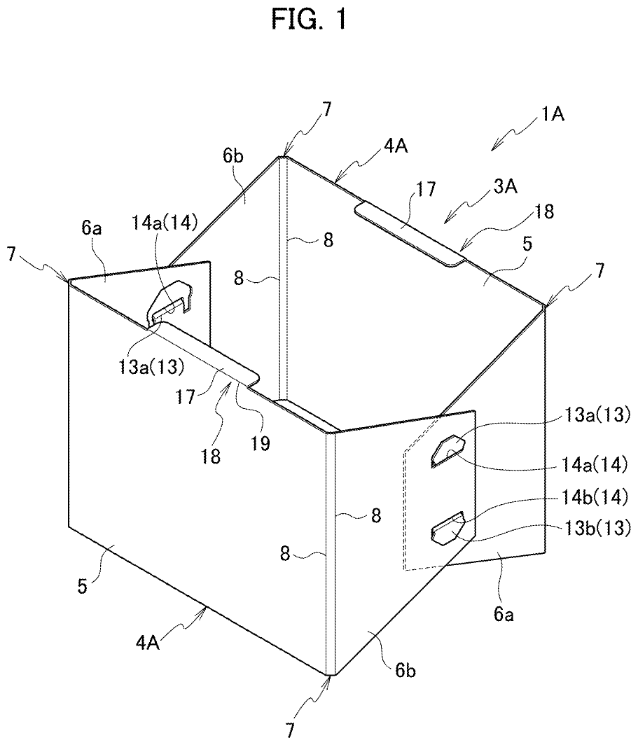

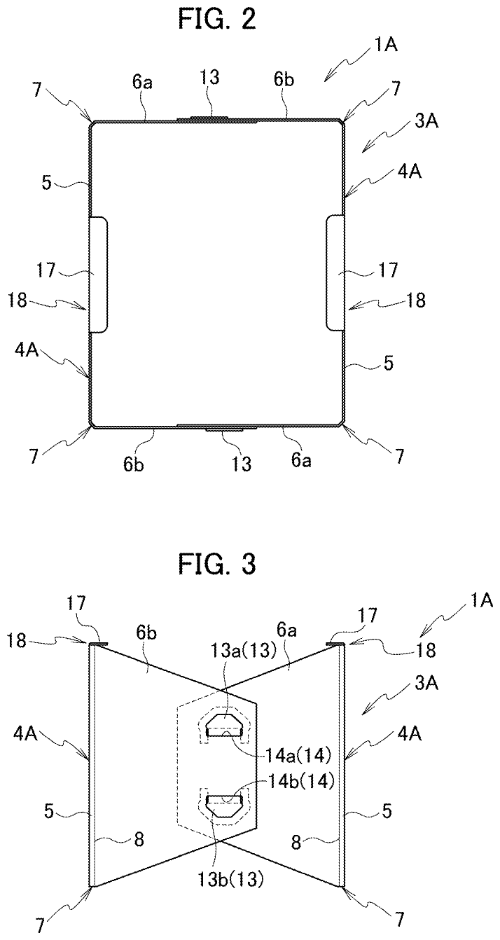

A vehicle battery cover (hereinafter referred to as “battery cover”) 1A according to an embodiment will be described with reference to FIGS. 1 to 4.

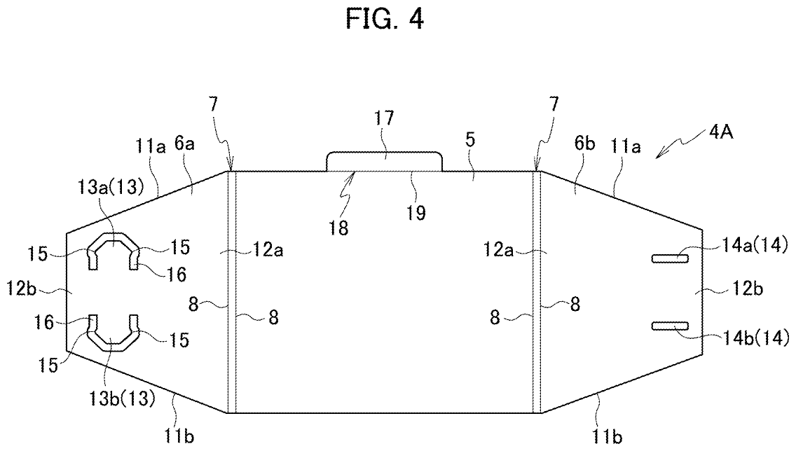

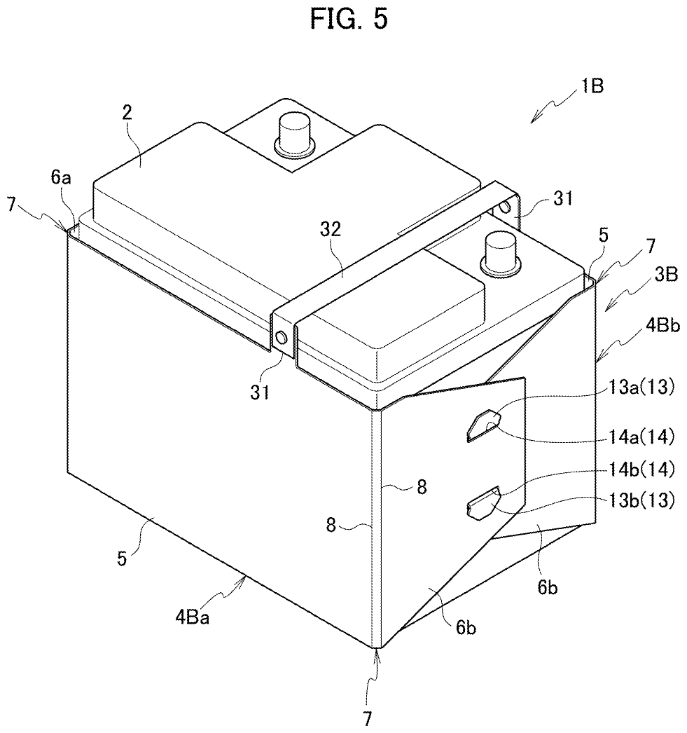

As shown in FIGS. 1 to 3, the battery cover 1A includes a cover body 3A formed into a square frame that surrounds and covers a battery 2 (see FIG. 5) mounted on a vehicle. The cover body 3A is formed into a square frame shape by combining two resin plates 4A and 4A (see FIG. 4).

Each of the resin plates 4A includes quadrangular body portions 5 and side surfaces 6a and 6b formed on both sides of the body portions 5 via hinges 7. Folding lines 8 functioning as the hinge 7 are formed between the side surfaces 6a and 6b and the body portions 5. Two folding lines 8 and 8 are formed in the respective hinges 7, thereby facilitating folding in the respective hinges 7.

The side surfaces 6a and 6b of the respective resin plates 4A are formed in a lateral trapezoidal shape with an upper edge portion 11a inclined obliquely downward from a base end 12a side toward a distal end 12b side and a lower edge portion 11b inclined obliquely upward from the base end 12a side toward the distal end 12b side (see FIG. 4).

Each of the side surfaces 6a and 6b of the respective resin plates 4A is formed with either a connecting piece 13 extending in a vertical direction or a hole portion 14 into which the connecting piece 13 is inserted (see FIG. 4).

As shown in FIG. 4, a first connecting piece 13a extending upward and a second connecting piece 13b extending downward are formed in the left side surface (first side surface) 6a of the respective resin plates 4A in FIG. 4. The first connecting piece 13a and the second connecting piece 13b are disposed in this order from above in the first side surface 6a of the respective resin plates 4A. That is, the first connecting piece 13a and the second connecting piece 13b are disposed in the first side surface 6a of the respective resin plates 4A with an interval therebetween in the vertical direction.

The first connecting piece 13a and the second connecting piece 13b are each formed in an arrow shape, and protrusions 15 functioning as stoppers slip-offs are formed on both sides of the front ends of the first connecting piece 13a and the second connecting piece 13b. Around the first connecting piece 13a and the second connecting piece 13b, arrow-shaped slits 16 generated by die cutting are formed.

Meanwhile, a first hole portion 14a into which the first connecting piece 13a is inserted and a second hole portion 14b into which the second connecting piece 13b is inserted are formed in the right side surface (second side surface) 6b of the respective resin plates 4A in FIG. 4. The first hole portion 14a and the second hole portion 14b are disposed in this order from above in the second side surface 6b of the respective resin plates 4A. That is, the first hole portion 14a and the second hole portion 14b are disposed in the second side surface 6b of the respective resin plates 4A with an interval therebetween in the vertical direction.

Each of the first hole portion 14a and the second hole portion 14b is formed into an elongated hole shape elongated in a lateral direction. By inserting the first connecting piece 13a and the second connecting piece 13b into the first hole portion 14a and the second hole portion 14b respectively, the two resin plates 4A and 4A are connected to each other.

As shown in FIGS. 1 to 3, the side surfaces 6a and 6b of the two resin plates 4A and 4A are superposed on each other in a state where the body portions 5 of the two resin plates 4A and 4A face each other. In this state, the two resin plates 4A and 4A are connected to each other by inserting the connecting piece 13 into the hole portion 14.

Specifically, the first side surface 6a of one resin plate 4A of the two resin plates 4A and 4A and the second side surface 6b of the other resin plate 4A are superposed on each other. In this state, the first connecting piece 13a of the first side surface 6a is inserted into the first hole portion 14a of the second side surface 6b, and the second connecting piece 13b of the first side surface 6a is inserted into the second hole portion 14b of the second side surface 6b.

The second side surface 6b of the one resin plate 4A is superposed on the outside of the first side surface 6a of the other resin plate 4A. In this state, the first connecting piece 13a is inserted so as to come out from the inside of the first hole portion 14a to the outside thereof, and the second connecting piece 13b is inserted so as to come out from the inside of the second hole portion 14b to the outside thereof. For this reason, the distal ends of the respective connecting pieces 13 and the protrusions 15 formed on both sides of the distal ends of the respective connecting pieces 13 are positioned outside the cover body 3A.

Each of the resin plates 4A includes a tab 17 at the center of the upper edge of the body portion 5 via a hinge 18 (folding line 19). The tab 17 is integrally extended from the body portion 5 of the respective resin plates 4A, and is bent inward via the hinge 18 (folding line 19).

A buffering member such as a sponge may be attached to an inner surface of the cover body 3A.

Although not shown, the battery cover 1A (cover body 3A) having the above-described configuration is foldable. Folding the battery cover 1A reduces the occupied volume, which makes transportation of the battery cover 1A easier. When the battery cover 1A is folded, the tab 17 is extended upward so as not to interfere with the folding process.

Further, when the battery cover 1A is folded, the body portion 5 and the side surfaces 6a and 6b adjacent to the body portion 5 are folded back toward each other until these are almost in contact with each other at the hinge 7. In this respect, as described above, the two folding lines 8 and 8 are formed in the respective hinges 7. For this reason, the battery cover 1A only needs to be folded by about 90 degrees at each of the folding lines 8, which makes folding of the battery cover 1A easier. When only one folding line is formed in the respective hinges 7, it is necessary to for the battery cover 1A to be completely folded back at this one folding line, and thus it may not be sufficiently folded at the folding line or stress acting on the folding line may become excessive.

The cover body 3A in this embodiment is formed by using two resin plates 4A shown in FIG. 4. The two resin plates 4A and 4A are formed into the same shape in a state where the side surfaces 6a and 6b and the tab 17 are unfolded to be flat. Each of the resin plates 4A is a die-cut polypropylene (PP) sheet, and can be easily folded while giving proper rigidity to the cover body 3A by using inexpensive polypropylene. Simply die-cutting a polypropylene sheet produces the resin sheet 4A shown in FIG. 4, which is easy to manufacture. The resin plates 4A and 4A may be a translucent natural color. By making the resin plates 4A and 4A translucent and natural in color, the liquid level position of battery liquid can be easily confirmed when the battery cover 1A (cover body 3A) is attached to the battery 2.

The operation and effect of this embodiment will be described below.

(1) The battery cover 1A includes a cover body 3A configured to surround a battery 2 (see FIG. 5) mounted on a vehicle, and the cover body 3A is formed by combining two resin plates 4A and 4A. The resin plates 4A include quadrangular body portions 5 and side surfaces 6a and 6b formed on both sides of the body portions 5 via hinges 7. Each of the side surfaces 6a and 6b of the resin plates 4A is formed with at least either a connecting piece 13 extending in a vertical direction or a hole portion 14 into which the connecting piece 13 is inserted. The side surfaces 6a and 6b of the two resin plates 4A and 4A are superposed on each other in a state where the body portions 5 of the two resin plates 4A and 4A face each other, and the two resin plates 4A and 4A are connected to each other by inserting the connecting piece 13 into the hole portion 14.

When the connecting piece 13 is inserted in the folding direction (lateral direction) of the cover body 3A, the connecting piece 13 may detach from the hole portion 14 when the cover body 3A is folded. In the battery cover 1A according to the present embodiment, since the connecting piece 13 is inserted in the vertical direction, which is a direction orthogonal to the folding direction of the cover body 3A, it becomes difficult for the connecting piece 13 to detach from the hole portion 14 when the cover body 3A is folded.

The two resin plates 4A and 4A are used when the cover body 3A is assembled, which makes it possible to reduce the size of each component.

As the cover body 3A is foldable, the occupied volume during transportation can be reduced, which makes it possible to improve the transportation efficiency.

It is not necessary to connect the cover body 3A so as to be formed into a frame with bolts, rivets, etc., which makes it possible to control interference with the battery 2 (see FIG. 5).

(2) The connecting piece 13 includes a first connecting piece 13a extending upward and a second connecting piece 13b extending downward, and the hole portion 14 includes a first hole portion 14a into which the first connecting piece 13a is inserted and a second hole portion 14b into which the second connecting piece 13b is inserted.

As the two resin plates 4A and 4A are connected by using the upward first connecting piece 13a and the downward second connecting piece 13b, it is more difficult for the connecting piece 13 to detach from the hole portion 14 when the cover body 3A is folded.

(3) The side surface 6b (second side surface) of one resin plate 4A where the hole portion 14 is formed is superposed on the outside of the side surface 6a (first side surface) of the other resin plate 4A where the connecting piece 13 is formed, and the connecting piece 13 is inserted so as to come out from the inside of the hole portion 14 to the outside thereof.

As the connecting piece 13 is inserted so as to come out from the inside of the hole portion 14 to the outside thereof, this makes it possible to prevent the connecting piece 13 (particularly the distal ends) from interfering with the battery 2 when the cover body 3A is attached to the battery 2 (see FIG. 5).

(4) The side surfaces 6a and 6b of the resin plates 4A are formed into a lateral trapezoidal shape with an upper edge portion 11a inclined obliquely downward from a base end 12a side toward a distal end 12b side and a lower edge portion 11b inclined obliquely upward from the base end 12a side toward the distal end 12b side.

As the side surfaces 6a and 6b of the resin plate 4A are formed into a trapezoidal shape, the distance from the upper edge portion 11a or the lower edge portion 11b of the side surfaces 6a and 6b to the connecting piece 13 decreases, and this makes it easier to insert the connecting piece 13 into the hole portion 14.

(5) The two resin plates 4A and 4A are formed into the same shape in a state where the side surfaces 6a and 6b are unfolded to be flat.

The use of two resin plates 4A and 4A having the same shape makes it possible to reduce the manufacturing cost of the battery cover 1A as compared with the case where the two resin plates 4A and 4A have different shapes.

(6) Each of the two resin plates 4A and 4A includes a tab 17 formed on an upper edge of the body portion 5.

The tab 17 functions as a handle when the cover body 3A attached to the battery 2 (see FIG. 5) is removed upward. In addition, various kinds of information (name of the cover material, type of battery to be installed, type of vehicle, etc.) can be written on the tab 17, and such information can be easily confirmed from above. When the battery 2 is fixed after the cover body 3A is attached to the battery 2, the tab 17 is sandwiched between the battery 2 and a fixing member (not shown in the drawings) so that the cover body 3A is also firmly fixed.

### Another Embodiment

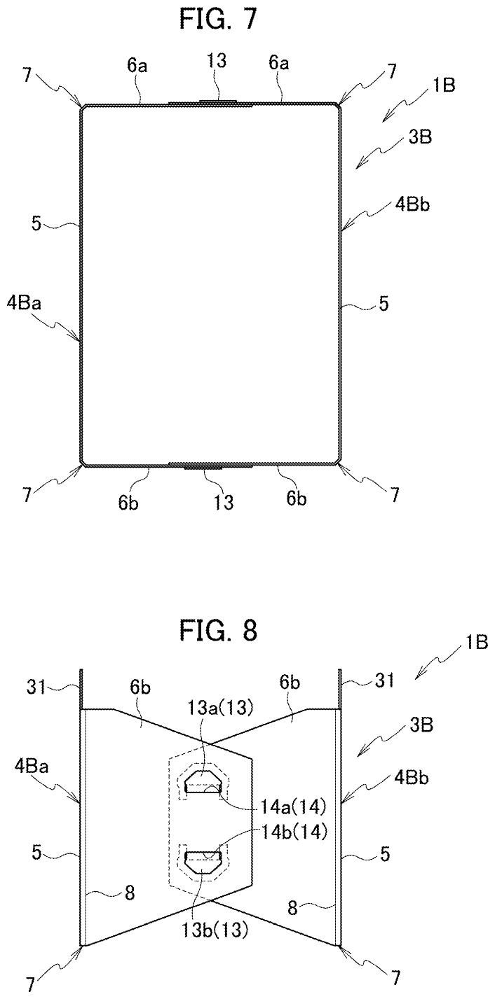

A battery cover 1B according to another embodiment will be described with reference to FIGS. 5 to 10. It should be noted that substantially the same components as those in the embodiments shown in FIGS. 1 to 4 are denoted by the same reference numerals, and overlapping descriptions are omitted.

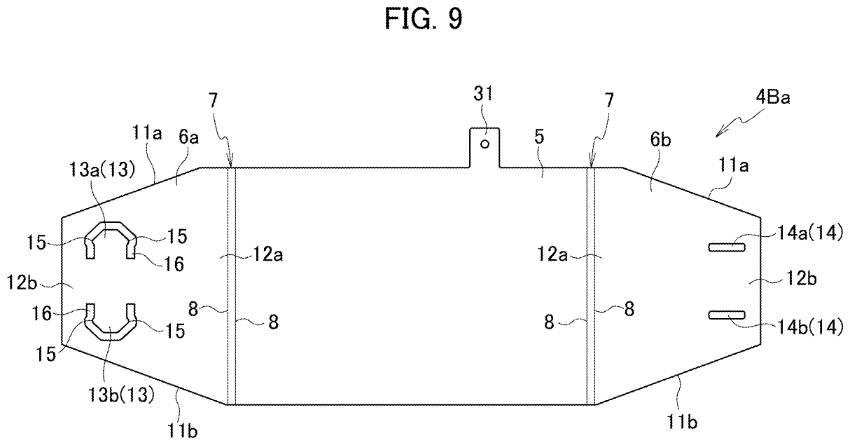

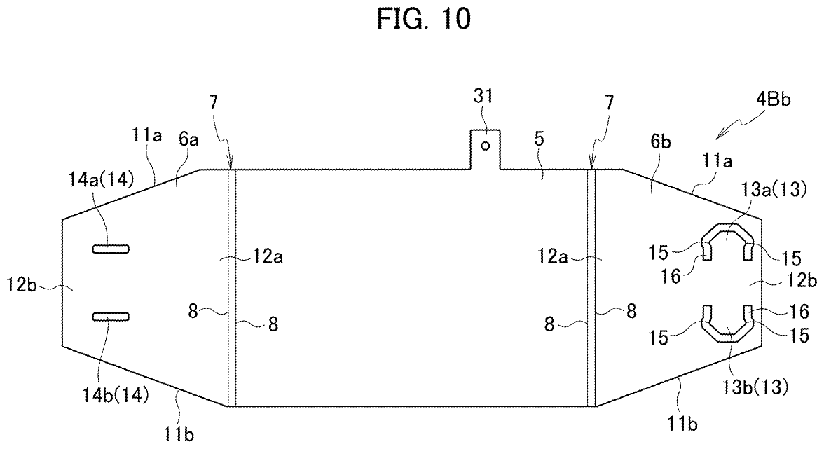

As shown in FIGS. 5 to 8, the battery cover 1B includes a cover body 3B formed into a square frame that surrounds and covers a battery 2 mounted on a vehicle. The cover body 3B is formed into a square frame shape by combining two resin plates 4Ba and 4Bb (see FIGS. 9 and 10).

Each side surface 6a and 6b of the respective resin plates 4Ba and 4Bb is formed with either a connecting piece 13 extending in the vertical direction or a hole portion 14 into which the connecting piece 13 is inserted (see FIGS. 9 and 10).

As shown in FIG. 9, a first connecting piece 13a extending upward and a second connecting piece 13b extending downward are formed in the left side surface (first side surface) 6a of the resin plate 4Ba. Meanwhile, a first hole portion 14a into which the first connecting piece 13a is inserted and a second hole portion 14b into which the second connecting piece 13b is inserted are formed in the right side surface (second side surface) 6b of the resin plate 4Bb in FIG. 9.

As shown in FIG. 10, the first hole portion 14a into which the first connecting piece 13a is inserted and the second hole portion 14b into which the second connecting piece 13b is inserted are formed in the left side surface (first side surface) 6a of the resin plate 4Bb. Meanwhile, the first connecting piece 13a extending upward and the second connecting piece 13b extending downward are formed in the right side surface (second side surface) 6b of the resin plate 4Bb in FIG. 10.

As shown in FIGS. 5 to 8, the side surfaces 6a and 6b of the two resin plates 4Ba and 4Bb are superposed on each other in a state where the body portions 5 of the two resin plates 4Ba and 4Bb face each other. In this state, the two resin plates 4Ba and 4Bb are connected to each other by inserting the connecting piece 13 into the hole portion 14.

Specifically, regarding the two resin plates 4Ba and 4Bb, the first side surface 6a of the first resin plate 4Ba and the first side surface 6a of the second resin plate 4Bb are superposed on each other. In this state, the first connecting piece 13a of the first resin plate 4Ba side is inserted into the first hole portion 14a of the second resin plate 4Bb side, and the second connecting piece 13b of the first resin plate 4Ba side is inserted into the second hole portion 14b of the second resin plate 4Bb side.

Further, the first side surface 6a of the second resin plate 4Bb is superposed on the outside of the first side surface 6a of the first resin plate 4Ba. In this state, the first connecting piece 13a is inserted so as to come out from the inside of the first hole portion 14a to the outside thereof, and the second connecting piece 13b is inserted so as to come out from the inside of the second hole portion 14b to the outside thereof. For this reason, the distal ends of the respective connecting pieces 13 and the protrusions 15 formed on both sides of the distal ends of the respective connecting pieces 13 are positioned outside the cover body 3B.

Meanwhile, the second side surface 6b of the first resin plate 4Ba is superposed on the second side surface 6b of the second resin plate 4Bb. In this state, the first connecting piece 13a of the second resin plate 4Bb side is inserted into the first hole portion 14a of the first resin plate 4Ba side, and the second connecting piece 13b of the second resin plate 4Bb side is inserted into the second hole portion 14b of the first resin plate 4Ba side.

Further, the second side surface 6b of the first resin plate 4Ba is superposed on the outside of the second side surface 6b of the second resin plate 4Bb. In this state, the first connecting piece 13a is inserted so as to come out from the inside of the first hole portion 14a to the outside thereof, and the second connecting piece 13b is inserted so as to come out from the inside of the second hole portion 14b to the outside thereof. For this reason, the distal ends of the respective connecting pieces 13 and the projections 15 formed on both sides of the distal ends of the respective connecting pieces 13 are positioned outside the cover body 3B.

Each of the resin plates 4Ba and 4Bb includes a connection section 31 formed at an offset position laterally shifted from the center of the upper edge of the body portion 5 (see FIGS. 9 and 10). The connection section 31 is integrally extended from the body portion 5 of the respective resin plates 4Ba and 4Bb. A strap 32 is attached to the respective connection sections 31 by crimping or the like and provided extending between the connection sections 31 of the two resin plates 4Ba and 4Bb. The strap 32 is made of a tape (polypropylene tape) material woven with nylon or polypropylene, but other materials may be used.

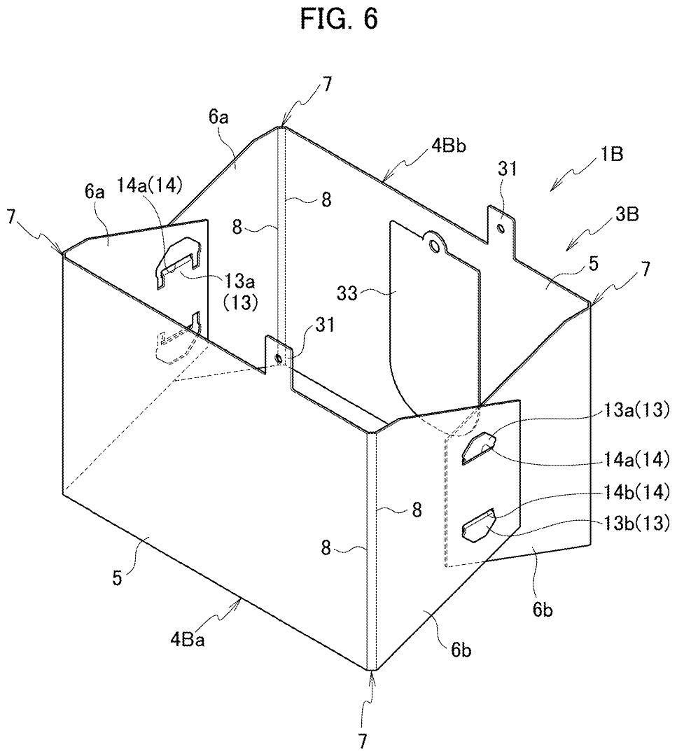

A rubber plate 33 is attached to a portion (in the present embodiment, the center portion in the lateral direction of the body portion 5 of the resin plate 4Bb disposed on the vehicle rear side (occupant side)) of the body portion 5 of the resin plates 4Ba and 4Bb where neighboring components may interfere with each other at the time of a vehicle collision (see FIG. 6). The rubber plate 33 is formed of, for example, ethylene propylene diene rubber (EPDM).

The operation and effect of the embodiment shown in FIGS. 5 to 10 will be described below.

In the embodiment shown in FIGS. 5 to 10, each of the two resin plates 4Ba and 4Bb includes the connection section 31 formed on the upper edge of the body portion 5, and the strap 32 is provided extending between the connection sections 31 of the two resin plates 4Ba and 4Bb.

As the strap 32 is attached to the respective two resin plates 4Ba and 4Bb, the battery 2 can be easily covered by holding the strap 32 when the battery 2 is to be covered with the cover body 3B. The strap 32 is placed over the battery 2 to prevent the cover body 3B from coming off and falling. As the strap 32 is attached in a state where the two resin plates 4Ba and 4Bb are unfolded, this makes it possible to transport and deliver the two resin plates 4Ba and 4Bb as a set.

In the embodiment shown in FIGS. 5 to 10, the rubber plate 33 is attached to a portion of the body portion 5 of the resin plate 4Bb where neighboring components may interfere with each other at the time of a vehicle collision (see FIG. 6).

As the rubber plate 33 is attached to the resin plate 4Bb, this makes it possible to prevent damage to the battery 2 due to impact when the vehicle has a collision.

### Yet Another Embodiment

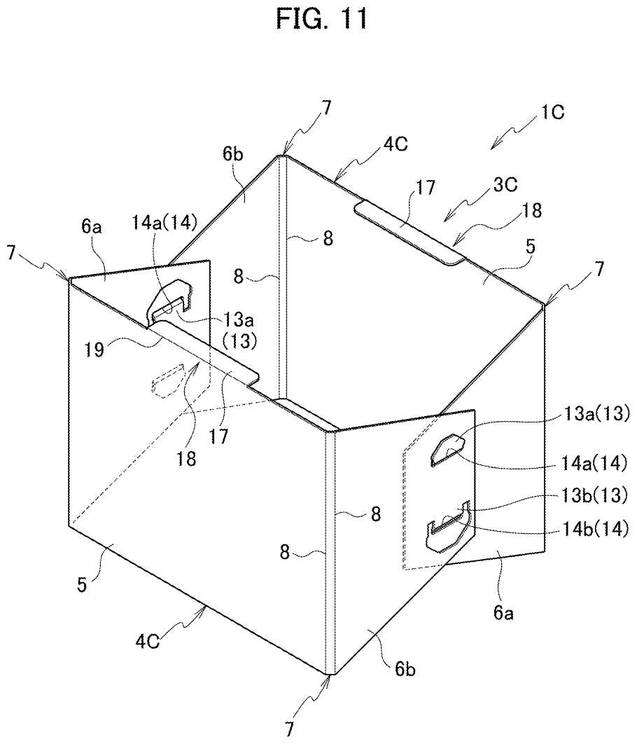

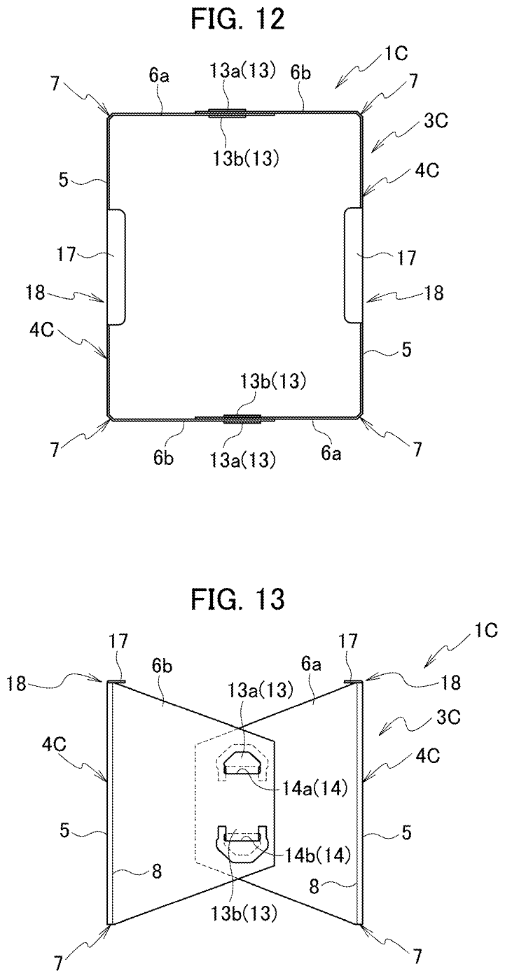

A battery cover 1C according to yet another embodiment will be described with reference to FIGS. 11 to 14. It should be noted that substantially the same components as those in the embodiments shown in FIGS. 1 to 4 are denoted by the same reference numerals, and overlapping descriptions are omitted.

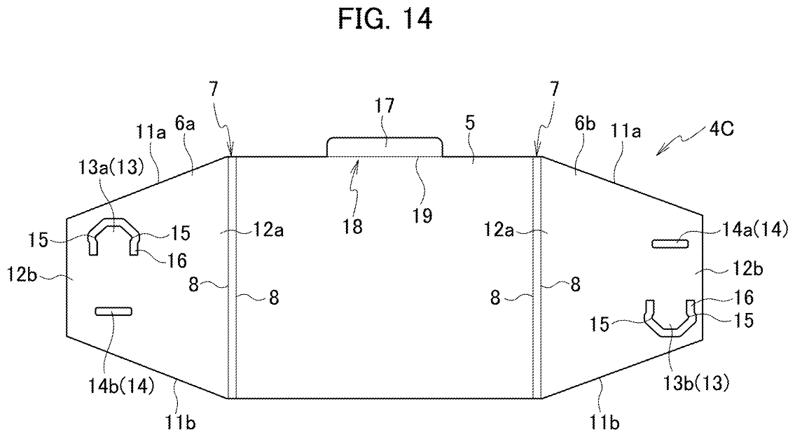

As shown in FIGS. 11 to 13, the battery cover 1C includes a cover body 3C formed into a square frame that surrounds and covers a battery 2 mounted on a vehicle. The cover body 3C is formed into a square frame shape by combining two resin plates 4C and 4C (see FIG. 14).

Each side surface 6a and 6b of the respective resin plates 4C is formed with both a connecting piece 13 and a hole portion (see FIG. 14).

As shown in FIG. 14, a first connecting piece 13a extending upward and a second hole portion 14b into which a second connecting piece 13b is inserted are formed in the left side surface (first side surface) 6a of the respective resin plates 4C in FIG. 14. The first connecting piece 13a and the second hole portion 14b are disposed in this order from above in the first side surface 6a of the respective resin plates 4C. That is, the first connecting piece 13a and the second hole portion 14b are disposed in the first side surface 6a of the respective resin plates 4C with an interval therebetween in the vertical direction.

Meanwhile, a first hole portion 14a into which the first connecting piece 13a is inserted and the second connecting piece 13b extending downward are formed in the right side surface (second side surface) 6b of the respective resin plates 4C in FIG. 14. The first hole portion 14a and the second connecting piece 13b are disposed in this order from above in the second side surface 6b of the respective resin plates 4C. That is, the first hole portion 14a and the second connecting piece 13b are disposed in the second side surface 6b of the respective resin plates 4C with an interval therebetween in the vertical direction.

As shown in FIGS. 11 to 13, the side surfaces 6a and 6b of the two resin plates 4C and 4C are superposed on each other in a state where the body portions 5 of the two resin plates 4C and 4C face each other. In this state, the two resin plates 4C and 4C are connected to each other by inserting the connecting piece 13 into the hole portion 14.

Specifically, the first side surface 6a of one resin plate 4C of the two resin plates 4C and 4C and the second side surface 6b of the other resin plate 4C are superposed on each other. In this state, the first connecting piece 13a of the first side surface 6a is inserted into the first hole portion 14a of the second side surface 6b, and the second connecting piece 13b of the second side surface 6b is inserted into the second hole portion 14b of the first side surface 6a.

The second side surface 6b of one resin plate 4C is superposed on the outside of the first side surface 6a of the other resin plate 4C. In this state, the first connecting piece 13a is inserted so as to come out from the inside of the first hole portion 14a to the outside thereof, and the second connecting piece 13b is inserted so as to come out from the outside of the second hole portion 14b to the inside thereof.

The operation and effect of the embodiment shown in FIGS. 11 to 14 will be described below.

In the embodiment shown in FIGS. 11 to 14, both the connecting piece 13 and the hole portion 14 are formed in each of the side surfaces 6a and 6b of the resin plates 4C. The side surface of one resin plate 4C is superposed on the outside of the side surface of the other resin plate 4C, and the connecting piece 13 formed in the side surface of the other resin plate 4C is inserted so as to come out from the inside of the hole portion 14 formed in the side surface of the one resin plate 4C, to outside thereof. In addition, the connecting piece 13 formed in the side surface of the one resin plate 4C is inserted so as to come out from the outside of the hole portion 14 formed in the side surface of the other resin plate 4C to the inside thereof.

The connecting piece 13, which is inserted as to come out from the inside of the hole portion 14 to the outside thereof, and the connecting piece 13, which is inserted so as to come out from the outside of the hole portion 14 to the inside thereof, are combined to connect the two resin plates 4C and 4C. Accordingly, when the cover body 3C is assembled by connecting the two resin plates 4C and 4C, it is more difficult for the connecting piece 13 to detach from the hole portion 14.

Although the vehicle battery cover of the present invention has been described by way of example in the foregoing invention, the present invention is not limited to this invention, and various other embodiments can be employed without leaving from the gist of the present invention.

What is claimed is:

1. A vehicle battery cover comprising:
a cover body configured to surround a battery mounted on a vehicle, wherein
the cover body is formed by combining two resin plates,
the resin plates include quadrangular body portions and side surfaces formed on both sides of the body portions via hinges,
each of the side surfaces of the resin plates is formed with at least either a connecting piece extending in a vertical direction or a hole portion into which the connecting piece is inserted, and
the side surfaces of the two resin plates are superposed on each other in a state where the body portions of the two resin plates face each other, and the two resin plates are connected to each other by inserting the connecting piece into the hole portion.

2. The vehicle battery cover according to claim 1, wherein
the connecting piece includes a first connecting piece extending upward and a second connecting piece extending downward, and
the hole portion includes a first hole portion into which the first connecting piece is inserted and a second hole portion into which the second connecting piece is inserted.

3. The vehicle battery cover according to claim 1, wherein
the side surface of one resin plate where the hole portion is formed is superposed on an outside of the side surface of the other resin plate where the connecting piece is formed, and the connecting piece is inserted so as to come out from an inside of the hole portion to an outside thereof.

4. The vehicle battery cover according to claim 1, wherein
both the connecting piece and the hole portion are formed in each of the side surfaces of the resin plates, and
the side surface of one resin plate is superposed on an outside of the side surface of the other resin plate, and the connecting piece formed in the side surface of the other resin plate is inserted so as to come out from an inside of the hole portion formed in the side surface of the one resin plate to outside thereof, and the connecting piece formed in the side surface of the one resin plate is inserted so as to come out from an outside of the hole portion formed in the side surface of the other resin plate to an inside thereof.

5. The vehicle battery cover according to claim 1, wherein
the side surfaces of the resin plates are formed into a lateral trapezoidal shape with an upper edge portion inclined obliquely downward from a base end side toward a distal end side and a lower edge portion inclined obliquely upward from the base end side toward the distal end side.

6. The vehicle battery cover according to claim 1, wherein
the two resin plates are formed into the same shape in a state where the side surfaces are unfolded to be flat.

7. The vehicle battery cover according to claim 1, wherein
each of the two resin plates includes a tab formed on an upper edge of the body portion.

8. The vehicle battery cover according to claim 1, wherein
each of the two resin plates includes a connection section formed on an upper edge of the body portion, and
a strap is provided extending between the connection sections of the two resin plates.

9. The vehicle battery cover according to claim 1, wherein
a rubber plate is attached to a portion of the body portion of the resin plates where neighboring components may interfere with each other at the time of a vehicle collision.
